(19) United States
(12) Patent Application Publication
(10) Pub. No.: US 2016/0270426 A1
(43) Pub. Date: Sep. 22, 2016

(54) COMPOSITION AND METHOD FOR EXTENDING SHELF LIFE OF LACTIC ACID BACTERIA

(71) Applicant: Nutrition Physiology Company, LLC, Guymon, OK (US)

(72) Inventor: Steven P. Lerner, Snellville, GA (US)

(21) Appl. No.: 15/074,826

(22) Filed: Mar. 18, 2016

Related U.S. Application Data
(60) Provisional application No. 62/134,911, filed on Mar. 18, 2015.

(51) Int. Cl. A23K 1/00

(52) U.S. Cl. CPC A23K 1/009; A23K 1/14; A23K 1/164; A23K 1/1756; A23Y 2220/07; A23Y 2220/03; A23Y 2320/25

(57) ABSTRACT

Methods and compositions are disclosed for enhancing the shelf life of probiotic bacteria, such as lactic acid bacteria (LAB). In one particular formulation, oil, soybean meal and a silicon-containing compound are mixed with LAB to extend the shelf life of the LAB to about six months or longer at normal ambient temperature.

### RELATED APPLICATION

This application claims priority to U.S. Patent Application No. 62/134,911, filed Mar. 18, 2015, which is hereby incorporated by reference in its entirety.

### BACKGROUND

I. Field of the Invention

The present disclosure pertains to the use of lactic acid producing bacteria and lactic acid utilizing bacteria (collectively referred to as “lactic acid bacteria” or LAB in this disclosure) to enhance the well-being of an animal, including humans. More particularly, the disclosure relates to extension of the shelf life of lactic acid bacteria by using oil and a combination of other agents.

II. Description of Related Art

Live lactic acid bacteria are used as probiotic supplements to enhance digestive and immune functions in humans. Live lactic acid bacteria have also been shown to improve feed efficiency and to reduce pathogens in animals, including ruminants and poultry. See, e.g., U.S. Pat. No. 5,534,271 and U.S. Pat. No. 8,734,785.

The dosage of lactic acid bacteria is typically measured by the live counts (colony forming unit, or CFU) of the bacteria. The CFUs of a particular batch may decrease during manufacture and storage of the bacteria. Loss of CFU may be exacerbated when the bacteria are exposed to moisture, or pre-mixed with animal feeds.

### SUMMARY

The present disclosure advances the art by providing methods and compositions for enhancing the shelf life of a microorganism, such as a probiotic bacterium. In one embodiment, the disclosed methods extend the shelf life of probiotic bacteria. In another embodiment, the disclosed methods extend the shelf life of probiotic bacteria that are mixed with animal feeds. The extension of shelf life may vary depending on the specific strains, but typically it may range from about one to six months without significant loss of CFU.

In one embodiment, the methods may include mixing and/or storing a microorganism (e.g., a probiotic bacterium) with a storage composition. In one embodiment, the storage composition may contain oil and a plant meal derived from plant material, such as seeds. In another embodiment, the storage composition may further contain a silicon-containing compound.

In one embodiment, different components of the storage composition may be mixed together before mixing with the microorganism to form a storage mix. In another embodiment, the microorganism may be mixed with oil and the silicon-containing compound first to form a pre-mixture, which is then mixed with the plant meal to form a storage mix.

In another embodiment, examples of oil to be used may include but are not limited to soybean oil, safflower oil, corn oil, palm oil, canola oil, or other vegetable oils or combinations thereof. In another embodiment, examples of oil may also include mineral oil. In one aspect, the oil may be present in the storage mix at a concentration of from about 5% to 15% (w/w), at about 6% to 12% (w/w), or at about 7.7% to 10.2% (w/w).

In one embodiment, examples of plant meal to be used may include but are not limited to soybean meal, corn meal, or combinations thereof. In another embodiment, the plant meal is an extruded soybean meal. In one aspect, the plant meal may be present in the storage mix at about 80% to 95% (w/w), at about 84% to 90% (w/w), or at about 87.5% (w/w).

In one aspect, the silicon-containing compound may have average particle size of from about 0.1 mm to about 5 mm In another aspect, the silicon-containing compound may be present in the storage mix at about 0.1% to 0.7% (w/w), about 0.2% to 0.5% (w/w), or about 0.4% to 0.5% (w/w).

In one embodiment, the microorganism may be a probiotic bacterium. In another embodiment, examples of the microorganism may include but are not limited to lactic acid producing bacterium, lactic acid utilizing bacterium or combination thereof. In another embodiment, the microorganism is a Lactobacillus animalis, a Lactobacillus acidophilus or a Propionibacterium freudenreichii bacterium. In another embodiment, the microorganism is a strain selected from the group consisting of LA51, M35, LA45, NP28, L411, D3, P9, P42, PF24 and combinations thereof.

In one embodiment, the bacterium may be mixed with the storage composition such that the concentration of the bacterium in the final mixture is between 1×10⁸ to 1×10¹² CFU per gram, between 1×10⁹ to 1×10¹¹ CFU per gram, or between 1×10¹⁰ to 6×10¹⁰ CFU per gram.

In one embodiment, the microorganism is freeze-dried or spray-dried before it is placed in contact with a component of the storage composition. In another embodiment, the probiotic bacterium is in a powder form before mixing with the soybean meal, oil, and the silicon-containing compound. In another embodiment, the microorganism has a water activity of less than 0.1, less than 0.08, or less than 0.06 before being placed in contact with a component of the storage composition.

In one embodiment, the storage composition is mixed with the probiotic bacterium and one or more types of animal feed.

According to one embodiment of the present disclosure, the probiotic bacterium that is mixed with the storage composition, with or without the animal feed, may retain 90% or more colony forming unit (CFU) after being stored at room temperature for at least three, four, five months, or even six months.

In another embodiment, the soybean meal may be in the form of a soybean oil cake. In one aspect, the soybean oil cake may be obtained as a solid by-product generated after grinding the soybean to extract soybean oil.

In one aspect, the soybean meal may be subject to grinding or other methods to reduce its particle size. In one embodiment, the particle size of the soybean meal may range from about 10 micrometers to about 500 micrometers, from about 25 micrometers to about 150 micrometers, or from about 50 micrometers to about 100 micrometers.

### BRIEF DESCRIPTION OF THE DRAWINGS

FIG. 1 shows loss of CFU over time when stabilized LA51 is stored in soybean oil as compared to results when other forms of LA51 are also stored in soybean oil and silica. M1 cells are LA51 in freeze-dried form. M2 cells are the same as M1 cells except M2 cells are protected by a commercial encapsulation coating that enhances the shelf life of the bacteria. M3 cells are stabilized LA51 cells. M4 cells are the same as M3 cells except M4 cells are further protected by the same commercial encapsulation coating of M2.

FIG. 2 shows loss of CFU over time when stabilized LA51 is stored in soy oil/soybean meal (SBM) and silica as compared to results when other forms of LA51 are also stored in soy oil/soybean meal and silica.

FIG. 3 shows loss of CFU over time when freeze-dried LA51 (not stabilized) is mixed with soybean oil and silica or soybean oil combined with soybean meal (SBM) and silica as compared to results obtained from non-stabilized freeze-dried LA51 cells that are not mixed with soybean oil or soybean meal (SBM), and stabilized LA51 cells mixed with soybean oil and silica or soybean oil combined with soybean meal and silica.

### DETAILED DESCRIPTION

The present disclosure provides improved methods and compositions for enhancing the shelf life of probiotic bacteria.

In one embodiment, probiotic bacteria may be mixed with a storage composition, which may contain oil and a plant meal derived from seeds. In another embodiment, the storage composition may also contain silicon-containing compound. In one aspect, the silicon-containing compound may absorb water or moisture and thus help keep the bacteria dry.

In one embodiment, the plant meal derived from seeds may be soybean meal also known as Soybean Oil Cake. Soybean meal may be a solid residue by-product generated after grinding the soybean to extract soybean oil. In one aspect, the soybean meal may contain small amount of oil.

In one embodiment, the soybean meal may provide increased surface area in the form of small particles to which the bacteria may adhere. In another embodiment, the soybean meal may also help absorb water away from the bacteria. In another embodiment, the particle size of the soybean meal may be reduced to increase its surface area. In another embodiment, the oil may help the bacteria adhere to the soy meal. Thus, the disclosed compositions and methods are different from encapsulation techniques in that the present disclosure does not require formation of an encapsulating film around the bacteria.

In one embodiment, the silicon-containing compound is selected from the group consisting of silicon dioxide, silicate, sodium aluminosilicate and combination thereof. In another embodiment, the silicon-containing compound may be made up of a substantially pure silicon dioxide or sodium aluminosilicate chemical. In another embodiment, the silicon-containing compound may be obtained from nature. In another embodiment, the silicon-containing compound may be processed to reduce the particle size.

In another embodiment, the term “stabilized” or “stabilization,” as used herein, refers to a technology used to create a matrix of material to protect freeze-dried bacteria. Details of this technology are described in Tobar et al., Oral vaccination of Atlantic salmon (Salmo salar) against salmonid rickettsial septicaemia. Vaccine 29: 2336-2340 (2011); and in U.S. patent application publication US20090238845, by Harel et al., entitled “Encapsulated vaccines for the oral vaccination and boostering of fish and other animals.” The term “non-stabilized” refers to microorganisms that have not been treated with this stabilization technology.

Various commercially available products are described or used in this disclosure. It is to be recognized that these products or associated trade names are cited for purpose of illustration only. Certain physical or chemical properties and composition of the products may be modified without departing from the spirit of the present disclosure. One of ordinary skill in the art may appreciate that under certain circumstances, it may be more desirable or more convenient to alter the physical and/or chemical characteristics or composition of one or more of these products in order to achieve the same or similar objectives as taught by this disclosure. It is to be recognized that certain products or organisms may be marketed under different trade names which may in fact be identical to the products or organisms described herein.

It is to be noted that, as used in this specification and the claims, the singular forms “a,” “an,” and ^{the} include plural referents unless the context clearly dictates otherwise. Thus, for example, reference to “a lactic acid producing bacterium” includes reference to one or more lactic acid producing bacteria.

The terms “between” and “at least” as used herein are inclusive. For example, a range of “between 5 and 10” means any amount equal to or greater than 5 but equal to or smaller than 10.

For purpose of this disclosure, the term “precede” means one event or step is started before a second event or step is started.

The dosage of the bacteria is defined by “CFU” which refers to the number of colony forming units of the particular bacterial strain that is mixed with the storage composition or the colony forming units of the particular bacterial strain that is present at the end of the storage period.

Preparation of the bacterial supplement to be mixed with feeds may be performed as described in U.S. Pat. No. 7,063,836. Enumeration of pathogenic bacteria may be conducted as described in Stephens et al. (2007). The contents of these references are hereby expressly incorporated by reference into this disclosure.

In one embodiment, the lactic acid producing bacterium may include one or more of the following: Bacillus subtilis, Bifidobacterium adolescentis, Bifidobacterium animalis, Bifidobacterium bifidum, Bifidobacterium infantis, Bifidobacterium longum, Bifidobacterium thermophilum, Lactobacillus acidophilus, Lactobacillus agilis, Lactobacillus alactosus, Lactobacillus alimentarius, Lactobacillus amylophilus, Lactobacillus amylovorans, Lactobacillus amylovorus, Lactobacillus animalis, Lactobacillus batatas, Lactobacillus bavaricus, Lactobacillus bifermentans, Lactobacillus bifidus, Lactobacillus brevis, Lactobacillus buchnerii, Lactobacillus bulgaricus, Lactobacillus catenaforme, Lactobacillus casei, Lactobacillus cellobiosus, Lactobacillus collinoides, Lactobacillus confusus, Lactobacillus coprophilus, Lactobacillus coryniformis, Lactobacillus corynoides, Lactobacillus crispatus, Lactobacillus curvatus, Lactobacillus delbrueckii, Lactobacillus desidiosus, Lactobacillus divergens, Lactobacillus enterii, Lactobacillus farciminis, Lactobacillus fermentum, Lactobacillus frigidus, Lactobacillus fructivorans, Lactobacillus fructosus, Lactobacillus gasseri, Lactobacillus halotolerans, Lactobacillus helveticus, Lactobacillus heterohiochii, Lactobacillus hilgardii, Lactobacillus hordniae, Lactobacillus inulinus, Lactobacillus jensenii, Lactobacillus jugurti, Lactobacillus kandleri, Lactobacillus kefir, Lactobacillus lactis, Lactobacillus leichmannii, Lactobacillus lindneri, Lactobacillus malefermentans, Lactobacillus mall, Lactobacillus maltaromicus, Lactobacillus minor, Lactobacillus minutus, Lactobacillus mobilis, Lactobacillus murinus, Lactobacillus pentosus, Lactobacillus plantarum, Lactobacillus pseudoplantarum, Lactobacillus reuteri, Lactobacillus rhamnosus, Lactobacillus rogosae, Lactobacillus tolerans, Lactobacillus torquens, Lactobacillus ruminis, Lactobacillus sake, Lactobacillus salivarius, Lactobacillus sanfrancisco, Lactobacillus sharpeae, Lactobacillus trichodes, Lactobacillus vaccinostercus, Lactobacillus viridescens, Lactobacillus vitulinus, Lactobacillus xylosus, Lactobacillus yamanashiensis, Lactobacillus zeae, Pediococcus acidilactici, Pediococcus pentosaceus, Streptococcus cremoris, Streptococcus diacetylactis, Streptococcus (Enterococcus) faecium, Streptococcus intermedius, Streptococcus lactis, Streptococcus thermophilus, and combinations thereof.

Examples of lactate utilizing bacterium may include Megasphaera elsdenii, Peptostreptococcus asaccharolyticus, Propionibacterium freudenreichii, Propionibacterium acidipropionici, Propionibacterium globosum, Propionibacterium jensenii, Propionibacterium shermanii, Propionibacterium spp., Selenomonas ruminantium, and combinations thereof.

In one embodiment, the lactic acid producing bacterium is Lactobacillus acidophilus, Lactobacillus animalis or Lactobacillus amylovorus. Examples of the lactic acid producing bacterium strains may include but are not limited to the LA51, M35, LA45, NP28 (a.k.a., C28), D3, or L411. In another embodiment, the lactic acid producing bacterium strain is LA51. The term Lactobacillus acidophilus/animalis may be used to indicate that either Lactobacillus acidophilus or Lactobacillus animalis may be used. It is worth noting that when strain LA51 was first isolated, it was identified as a Lactobacillus acidophilus by using an identification method based on positive or negative reactions to an array of growth substrates and other compounds (e.g., API 50-CHL or Biolog test). Using modern genetic methods, however, strain LA51 has been confirmed as belonging to the species Lactobacillus animalis (unpublished results). Regardless of the possible taxonomic changes for LA51, the strain LA51 remains the same as the one that has been deposited with ATCC.

Lactobacillus strains C28, M35, LA45 and LA51 were deposited with the American Type Culture Collection (ATCC) on May 25, 2005 and have the Deposit numbers of PTA-6748, PTA-6751, PTA-6749 and PTA-6750, respectively. Lactobacillus strain L411 was deposited with the American Type Culture Collection (ATCC) on Jun. 30, 2005 and has the Deposit number PTA-6820. Pediococcus strain D3 was deposited with the American Type Culture Collection (ATCC, Manassas, Va. 20110-2209) on Mar. 8, 2006 and has the Deposit number of PTA-7426. Propionibacterium strains P9 and P42 were deposited with the American Type Culture Collection (ATCC) on Jun. 30, 2005 and have the Deposit numbers of PTA-6821 and PTA-6822, respectively. Propionibacterium strain PF24 was deposited with the American Type Culture Collection (ATCC) on May 26, 2005 and has the Deposit number of PTA-6752b .

These deposits were made in compliance with the Budapest Treaty requirements that the duration of the deposit should be for thirty (30) years from the date of deposit or for five (5) years after the last request for the deposit at the depository, or for the enforceable life of a patent that results from this application, whichever is longer. The strains will be replenished should it become non-viable at the Depository.

The following examples are provided to illustrate the present disclosure, but are not intended to be limiting. The feed ingredients and supplements are presented as typical components, and various substitutions or modifications may be made in view of this disclosure by one of skills in the art without departing from the principle and spirit of the present invention. Unless otherwise specified, the percentages of ingredients used in this disclosure are on a w/w basis.

### EXAMPLE 1

### Storage of LAB in Oil Without Soybean Meal

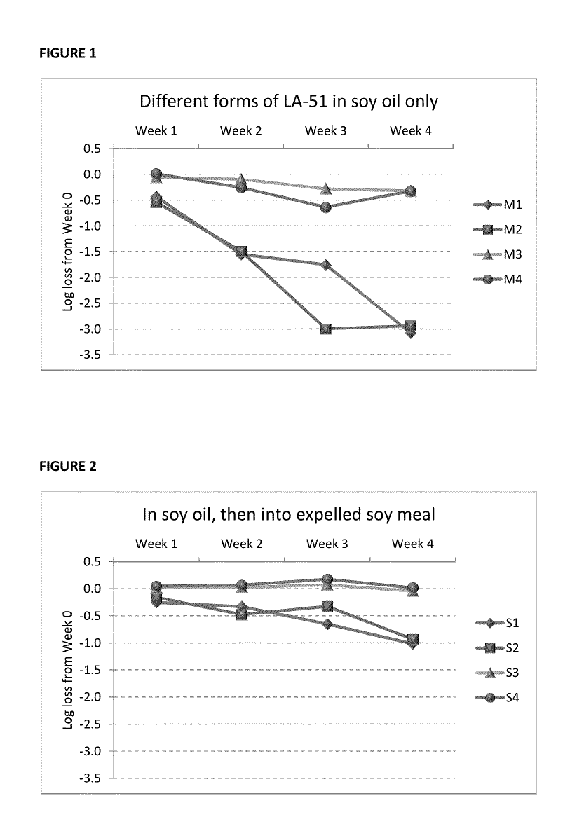

This example describes the storage of lactic acid producing bacteria (LAB) in soy oil only. LA51 (a.k.a., LA-51 or NP51) was used in this study. CFU of the LA51 protected by soy oil and silica only was measured and compared with LAB that were prepared by different methods. The bacteria were stored at room temperature after mixing with soy oil and silica. The CFUs of the bacteria in each formulation were determined at weeks 1, 2, 3, and 4 via standard enumeration techniques (12 enumerations each week). Loss of CFU was calculated and results are shown in FIG. 1. M1 was LA51 in freeze-dried form in soybean oil and silica. M2 cells were the same as M1 cells except M2 cells were protected by a commercial encapsulation coating that enhances the shelf life of the bacteria. M3 was stabilized LA51 cells with soybean oil and silica only. The LA51 cells were stabilized according to methods described in Tobar et al. (2011) and Harel et al. (2009). M4 cells were the same as M3 cells except M4 cells were also protected by the same commercial encapsulation coating of M2. As shown in FIG. 1, the stabilized M3 cells had the least loss of CFU among all samples tested. However, some loss of CFU was still observed in M3 and M4 cells.

### EXAMPLE 2

### Storage of LAB in Oil and Soybean Meal

This example describes the storage of lactic acid producing bacteria (LAB) in soy oil and expelled soy meal (soybean meal). Two different starting concentrations of the LAB were used for comparison.

In Formulation I, ten grams of LA51 strain (at a starting concentration of 8×10¹⁰ CFU/g) were mixed with 0.9 gram of silica (i.e., silicon dioxide) and 17.4 grams of soybean oil to form a pre-mixture. One ounce (or about 28.35 grams) of this pre-mixture was mixed with 198.45 grams of soybean meal to obtain the final mixture. The final mixture contained, by weight, about 4.4% of LAB, 0.4% of silica, 7.7% of soy oil, and 87.5% of soybean meal.

In Formulation II, four grams of LA51 strain (at a starting concentration of 2×10¹¹ CFU/g) were mixed with 1.2 grams of silica and 23.1 grams of soybean oil to form a mixture. One ounce (or about 28.35 grams) of this mixture was mixed with 198.45 grams of soybean meal to obtain the final mixture. The final mixture contained, by weight, about 1.8% of LAB, 0.5% of silica, 10.2% of soy oil, and 87.5% of soybean meal.

The bacteria were stored at room temperature after mixing with soy oil, soybean meal and silica. CFU of the LA51 protected by Formulation I was measured and compared with the same bacteria that were prepared by different methods. The CFUs of the bacteria in each formulation were determined at weeks 1, 2, 3, and 4 via standard enumeration techniques (12 enumerations each week). Loss of CFU was calculated and the results are shown in FIG. 2. S1 was LA51 in freeze-dried form in soybean oil, expelled soybean meal and silica. S2 cells were the same as the S1 cells except S2 cells were also protected by a commercial encapsulation coating that is supposed to enhance the shelf life of the bacteria. S3 cells were stabilized LA51 cells protected with the presently disclosed formulation with soy oil, soy meals and silica. S4 cells were protected by the same formulation as S3 cells but S4 cells were further protected by the same commercial encapsulation coating of S2. As shown in FIGS. 2, S3 and S4 cells show almost no loss of CFU as compared to other samples tested.

In another test, LA51 was stored with (1) soybean oil only, or (2) with soybean oil and soybean meal and the CFU was measured weekly for 12 weeks. The formulation with both soybean oil and soybean meal showed no significant loss of CFU while the formulation with soybean oil only had slightly more loss of CFU (about 0.5 log CFU loss).

### EXAMPLE 3

### Non-stabilized LAB Protected by Soy Oil and Soybean Meal

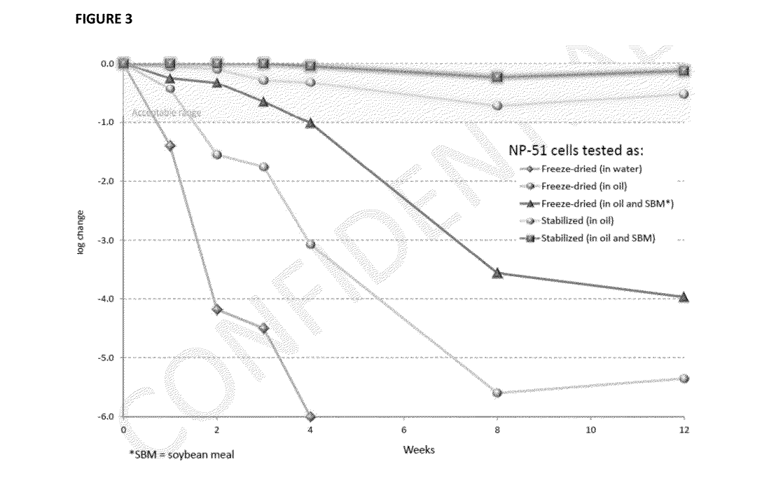

FIG. 3 shows loss of CFU by non-stabilized LA51 in freeze-dried form as compared to non-stabilized LA51 in freeze-dried form mixed with soybean oil and silica, and non-stabilized LA51 in freeze-dried form mixed with soybean oil, expelled soybean meal and silica. Soybean oil and silica extended the shelf life to some extent, while soybean oil, expelled soybean meal and silica showed a greater effect in extending the shelf life of the bacteria.

### EXAMPLE 4

### Extension of Shelf-life of LAB When Mixed with Feed

This experiment was performed to test the shelf life of probiotic bacteria when mixed with animal feed. More specifically, LA51 strain was mixed with cattle feeds with or without the disclosed storage composition containing oil, soybean meal and silicon dioxide.

The CFUs of the bacteria in each formulation were measured each week for 3 months via standard enumeration techniques (12 enumerations each week). LA51 treated with the disclosed storage composition showed almost no CFU loss (less than 0.5 log reduction) when mixed with feed. By contrast, steep loss of CFU (4.5 log reduction) was observed in the LA51 and feed mixture not treated with the disclosed storage composition.

### LIST OF REFERENCES

The following references, patents and publication of patent applications are either cited in this disclosure or are of relevance to the present disclosure. All documents listed below, along with other papers, patents and publication of patent applications cited throughout this disclosures, are hereby incorporated by reference as if the full contents are reproduced herein

1. US Patent application Publication No. US2007/0122397 A1.

2. Stephens et al., J. of Food Protection, Vol. 70, pages 2386-91 (2007).

3. Tobar et al., Oral vaccination of Atlantic salmon (Salmo salar) against salmonid rickettsial septicaemia. Vaccine 29: 2336-2340 (2011).

4. Harel et al., U.S. patent application publication US20090238845, Encapsulated vaccines for the oral vaccination and boostering of fish and other animals.

We claim:

1. A composition for storing a microorganism, said composition comprising:
(a) oil;
(b) silicon-containing compound; and
(c) a plant meal derived from seeds.

2. The composition of claim 1, wherein said oil is selected from the group consisting of soybean oil, safflower oil, corn oil, palm oil, canola oil, mineral oil, and combinations thereof.

3. The composition of claim 1, wherein said plant meal is soybean meal.

4. The composition of claim 1, wherein said oil is present in said composition at about 5% to 15% (w/w).

5. The composition of claim 1, wherein said oil is present in said composition at about 7.7% to 10.2% (w/w).

6. The composition of claim 1, wherein said silicon-containing compound is selected from the group consisting of silicon dioxide, silicate, sodium aluminosilicate and combination thereof.

7. The composition in claim 1, wherein said silicon-containing compound is silicon dioxide and said silicon dioxide is present in said composition at about 0.1% to 0.7% (w/w).

8. The composition of claim 1, wherein said plant meal is present in said composition at about 80% to 95% (w/w).

9. The composition of claim 1, wherein said plant meal is an extruded soybean meal.

10. The composition of claim 1, wherein said microorganism is stabilized.

11. A composition comprising
(a) oil;
(b) silicon-containing compound;
(c) a plant meal derived from seeds; and
(d) a probiotic bacterium.

12. The composition of claim 11, wherein said plant meal is soybean meal.

13. The composition of claim 11, wherein said probiotic bacterium is a member selected from the group consisting of lactic acid producing bacterium, lactic acid utilizing bacterium, and combinations thereof.

14. The composition of claim 11, wherein said probiotic bacterium is a member selected from the group consisting of Lactobacillus animalis, Lactobacillus acidophilus, Propionibacterium freudenreichii and combinantions thereof.

15. The composition of claim 11, wherein said probiotic bacterium is a strain selected from the group consisting of LA51, M35, LA45, NP28, L411, D3, P9, P42, PF24 and combinations thereof.

16. The composition of claim 11, wherein said probiotic bacterium is stabilized.

17. The composition of claim 11, wherein said probiotic bacterium has a water activity of less than 0.08.

18. The composition of claim 11, wherein said probiotic bacterium retains 90% or more colony forming unit (CFU) after being stored at room temperature for three months with said oil and soybean meal.

19. The composition of claim 11, wherein said probiotic bacterium retains 90% or more colony forming unit (CFU) after being stored at room temperature for six months with said oil and soybean meal.

20. The composition of claim 1, wherein said soybean meal has particle size ranging from about 25 micrometers to about 150 micrometers.

21. The composition of claim 11, wherein said probiotic bacterium is present in said composition at a concentration of between 1×10¹⁰ to 6×10¹⁰ CFU per gram.

22. The composition of claim 11, wherein said composition further comprises an animal feed.

23. A method of extending shelf-life of a probiotic bacterium, said method comprising (a) mixing said probiotic bacterium with soybean meal, soybean oil, and a silicon-containing compound.

24. The method of claim 23, further comprising a step (b) storing the mixture of step (a) at a desired temperature.

25. The method of claims 23, wherein said mixture of step (a) further comprises an animal feed.

26. The method of claim 23, wherein said probiotic bacterium is stabilized.
